(19) United States
(12) Patent Application Publication
(10) Pub. No.: US 2012/0223953 A1
(43) Pub. Date: Sep. 6, 2012

(54) Kinematic Engine for Adaptive Locomotive Control in Computer Simulations

(75) Inventor: Alex Osuna, Phoenix, AZ (US)

(73) Assignee: ANGEL GAMING, LLC, Phoenix, AZ (US)

(21) Appl. No.: 13/412,335

(22) Filed: Mar. 5, 2012

Related U.S. Application Data
(60) Provisional application No. 61/464,501, filed on Mar. 4, 2011.

(51) Int. Cl. G06T 13/00

(52) U.S. Cl. 345/473

(57) ABSTRACT

An adaptive locomotion control system is used within the physics processing of a computer simulation engine. The control system is applied to one or more ragdoll models which represent entities in a computer simulation. The control system applies state-detection, equation-of-motion, and applied-force functions to maintain the model's balance while standing still and while executing simple or complex movements. In one embodiment, the functions manipulate the model in a manner similar to the muscles of the modeled organism, particularly a human. In another embodiment, the functions apply spot forces to keep the model upright and to perform movements.

### CROSS-REFERENCE TO RELATED APPLICATIONS

This application claims the benefit of co-pending provisional application No. 61/464,501 filed Mar. 4, 2011.

### FIELD OF INVENTION

This invention relates to computer graphic simulations. This invention relates particularly to a system and method for simulating locomotion of an organic entity in two and three dimensions.

### BACKGROUND

Graphical computer simulations are built on a processing engine designed to work on one or more platforms, such as arcade or console video game systems or personal computers. The processing engine includes a graphics engine, which renders computer-generated imagery (“CGI”) and other graphics, typically by identifying, describing, and rendering thousands of polygons that embody the elements of the simulation. The processing engine also includes a physics engine, which implements the physical constraints of the simulated environment according to a predetermined set of physical rules. A key concern is that the processing engine simulate, with a high degree of realism, the natural locomotion of an entity within the simulated environment. Unfortunately, it is very difficult to simulate realistic movement, particularly of a simulated human figure, due to the many variables that affect movement in the real world. These variables include the properties of the entity as well as external forces, such as gravity and wind, that work on the entity.

Typically within interactive simulations, such as video games, the variables affecting entity locomotion are greatly reduced by limiting the possible movements to a finite set, and then producing one or more animations of each movement. When the entity moves or interacts with the environment, the processing engine is alerted to retrieve and play the pre-recorded animation. An effective manner of achieving three-dimensional realistic movement of an organically-moving entity uses motion capture technology. To build the simulation, a finite set of predetermined character animations are filmed using a motion capture system. Typically, this involves placing numerous movement sensors on an actor in order to capture movement data representing the actor's limbs and torso as the actor performs certain actions. The data is then mapped to a “skeleton” character model in the simulation. The graphics and physics engines may then render the model performing the recorded actions in the simulation.

There are four main drawbacks to pre-animating a finite set of movements. First, it incurs significant development time, as the actions must be choreographed, recorded, and then mapped to the model. It is estimated that 70%-90% of the development time in a large-scale video game may be spent on pre-animation. Second, the simulated entity can only perform the predetermined actions and no others. Third, a pre-animated entity may not be subjected to all of the limitations of the physical environment while it is performing the animation, presenting unrealistic results. For example, a simulated human may execute a pre-animated leap and collide with a wall before the animation is completed. The animated movement may finish even though the character is no longer moving forward. Fourth, the prefabricated animations require significant memory and processing resources to store and retrieve. A processing engine that addresses these drawbacks is needed.

Many known two- and three-dimensional processing engines achieve some real-time animation of entity movement using “ragdoll physics.” This technique represents the entity as a model of jointed rigid bodies, the model being subject to the physical rules of the environment. When animated in real-time, the model collapses to the simulated ground, its movement conditioned by the properties of the rigid bodies and joints. The effect resembles the movements of a child's ragdoll, and as such is used to simulate “dying” characters. Such “death scenes” may be more realistic and non-repetitive than pre-animated scenes because the model interacts with the physical environment. Such interaction would resolve many of the drawbacks of pre-animated entity locomotion, and it would be advantageous to apply the ragdoll concept to all aspects of simulated movement.

Therefore, it is an object of this invention to provide a processing engine for simulating locomotion of human and other organically-moving entities within a physical environment. It is a further object that the processing engine allow entity movement without restriction to predetermined animations. It is another object of the invention to improve the processing of ragdoll physics so that a ragdoll model may be used to represent all movements of a simulated entity.

### SUMMARY OF THE INVENTION

The present invention is a system and methods for creating two- or three-dimensional (“2D” or “3D”) computer simulations of human and other organic or organic-like entities by utilizing the physical rules of the simulation in place of pre-animating the entities' movements. An adaptive locomotion control system controls a ragdoll model that represents the entity in the physics engine. Controls imparted by the control system include maintaining the model's vertical balance while standing still and moving, processing the effect of a user's keystrokes on the model, and reacting to and interacting with objects in the simulated environment. In one embodiment, the control system detects the movement of the rigid bodies within the model and applies external forces to specific points on the model to affect balance, posture, and movement of limbs. In another embodiment, the control system rotates certain joints to maintain the model's balance or otherwise cause the model to move. The features of each embodiment may be combined to create dynamic models, which are bound by environmental conditions of the simulation.

### BRIEF DESCRIPTION OF THE DRAWINGS

FIG. 1 is a front view diagram of a first embodiment of a ragdoll model.

FIG. 2 is a right side cross-sectional diagram of the first embodiment of the ragdoll model taken along line 2-2 of FIG. 1 showing an external force balancing method.

FIG. 3 is a front view diagram of a second embodiment of a ragdoll model.

FIG. 4A is a right side cross-sectional diagram of the second embodiment of the ragdoll model taken along line 4-4 of FIG. 3 showing a first internal rotation balancing method.

FIG. 4B is a right side cross-sectional diagram of the second embodiment of the ragdoll model taken along line 4-4 of FIG. 3 showing a second internal rotation balancing method.

FIG. 5A is a left side view diagram of a third embodiment of a ragdoll model showing a first position of an external force movement method.

FIG. 5B is a left side view diagram of the ragdoll model of FIG. 5A showing a second position of the external force movement method of FIG. 5A.

### DETAILED DESCRIPTION OF THE INVENTION

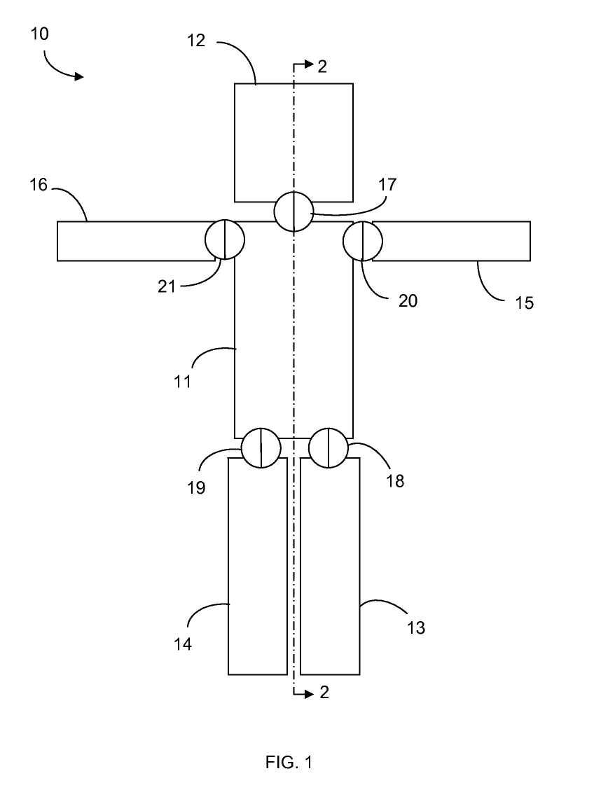

Referring to FIG. 1, the present invention is an adaptive locomotion control system for animating a ragdoll model 10, which represents an entity that moves organically in a computer simulation. The ragdoll model 10 comprises a plurality of rigid bodies, commonly referred to in the art as “bones,” interconnected by joints in the same way the skeleton of a human, humanoid, or other animal is constructed. In the example of FIG. 1, the bones include a torso 11, head 12, left leg 13, right leg 14, left arm 15, and right arm 16, and the joints include a neck joint 17, left hip joint 18, right hip joint 19, left shoulder joint 20, and right shoulder joint 21. The FIG. 1 example is a simple approximation of a human skeleton, lacking knees, elbows, ankles, and vertebral joints, the inclusion of which would allow more complex and realistic movements. Some more complex models 10 are described below, and it will be understood from the description that a model 10 of any useful complexity, including humanoid models and models having more than two legs, may be used in the described methods. In one embodiment, particularly for 2D simulations, each bone may comprise one or more polygons having predetermined properties such as dimensions, mass, and coefficient of restitution. In another embodiment, polygons and textures may be attached to or associated with the bones for rendering in the simulation, as is known particularly in the art of 3D modeling and simulation. Each joint may have predetermined properties as well, such as limitations on direction, degree, and speed of rotation.

The simulation is generated by a processing engine having a graphics engine and a physics engine as described above, and the control system works within the parameters of the physics engine. Preferably, the control system may be adapted for use with an existing processing engine, such as Box2D, HAVOK® Physics, Vortex, and Diesel. When placed within the simulation, a typical ragdoll model 10 will not be subject to any external or internal balancing forces, thus its collapse to the ground “like a ragdoll” as the bones, pulled by the gravity in the environment, pivot around the joints until they reach equilibrium. The control system provides balance and locomotion to the model 10 through a combination of state detection and external, internal, or a combination of external and internal applications of force.

External Force Balancing

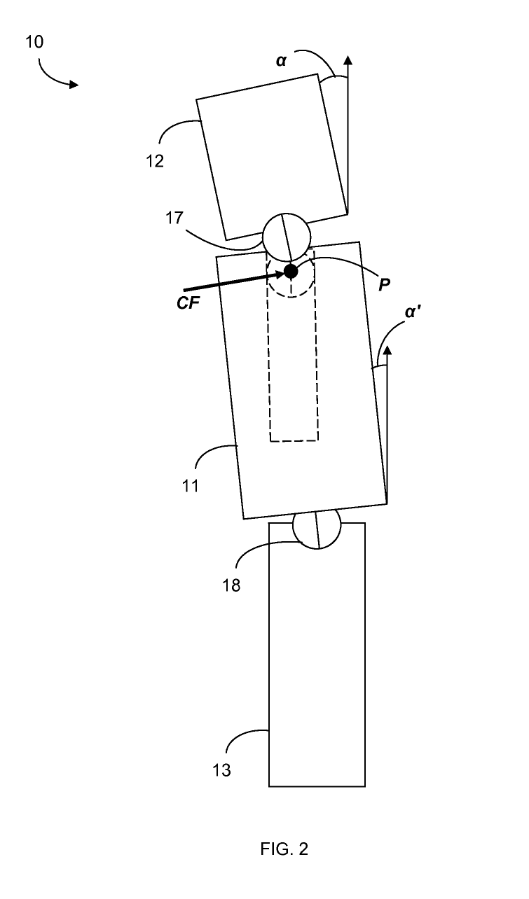

Referring to FIG. 2, the control system may balance the model 10 in an upright position by substantially continuously detecting the orientation of either or both of the torso 11 and head 12 and applying a corrective force CF to the model 10 at a predetermined point P when the model 10 begins to lean. Preferably, the control system first obtains the angle α at which the head 12 is tilted with respect to a vertical line, but alternatively the control system may use the angle α′ of the torso 11 with respect to vertical. The angle α is converted, using trigonometric functions on a unit circle, into a Euclidean vector having components along each axis that is perpendicular to the reference line. In a 2D simulation with “vertical” being along the y-axis in the positive direction, the x-axis component is determined by the sine of the angle α and the y-axis component is determined by the cosine of the angle α. In a 3D simulation with “vertical” being along the z-axis in the positive direction, it is valuable to obtain both the angle from vertical along the x-axis (“A1”) and the angle from vertical along the y-axis (“A2”). The x-axis component is determined by multiplying the cosine of A1 with the sine of A2, the y-axis component is obtained from multiplying the sine of A1 with the sine of A2, and the z-axis component is determined by the cosine of A2. In alternative embodiments, the angle α may be measured with respect to a different reference line than vertical. It will be understood that the trigonometric functions used to determine the vector components are selected according to the frame of reference used.

The vector components are used to apply the corrective force, but they first may be multiplied by a value representing the magnitude needed to push the model 10 back toward vertical. The magnitude depends on the mass of the model 10 and any limitations placed on the rotation of joints in the model 10, as well as gravity and other environmental factors. The magnitude may further depend on the distance of the chosen point P from the center of mass of the model 10. Specifically, the closer the point P is to the center of mass, the greater the magnitude of force needed to right the model 10. In order to maintain realism of the simulation, the magnitude may be chosen with the goal of applying the least amount of force needed to balance the model 10 on a flat surface with no other external forces. Thus, other factors within the simulated environment, such as wind, entity movement, collisions, and surface slope may overcome the corrective force and knock over the model 10. As the complexity of the environment requires and provided processing power permits, the control system may repeatedly calculate the optimal magnitude for the corrective force CF to compensate for these environmental factors. Alternatively or in addition, the selected magnitude may be greater than necessary, giving the model 10 a higher degree of balance which may be desired depending on the type of simulation. It will be understood that the increased magnitude may result in overcorrection of the model's 10 lean, which the control system may account for by applying another corrective force to counteract the overcompensation.

The corrective force CF is comprised of the scaled-up vector components. The force CF is applied to the point P, preferably in substantially the opposite direction of the model's 10 lean. The force CF may be applied to the model 10 as a whole or to a particular bone within the model 10. That is, within an object-oriented programming structure, the instance of the model 10 may be comprised of an instance of each of the bones, so that programming functions may be performed upon either the model 10 or any of its components with potentially different results. Preferably, the force CF is applied to the instance of the torso 11, which causes the torso 11 to act similarly to a weighted lever rotating about the hip joints 18, 19. The point P may be above the center of mass of either the torso 11 alone or of the entire model 10, depending on the model's 10 composition. The point P is preferably on the axis of the torso 11, as illustrated in FIG. 2 where the point P is on the axis A, which also passes through the center of mass C of the torso 11. The distance of point P from the center of mass C may be determined based on the characteristics of the model 10. The point P may be substantially at the neck joint 17 as illustrated in FIG. 2, or may be between the neck joint 17 and the center of mass C, or may be above the model 10. As stated, the force CF is recalculated and reapplied substantially continuously, preferably with a frequency equal or approximately equal to the frame rate of the simulation.

The model's 10 lean may be tested at multiple points, with a plurality of corrective forces being applied. In the preferred embodiment, a corrective force is applied at or near each set of hips on a model 10. Thus, for a model 10 representing a four-legged animal, the detection and correction may be performed substantially simultaneously at two different positions. The external balancing method may alternatively be applied in conjunction with the internal rotation balancing method described below, such that joint rotation is used to internally balance the model 10, and the external spot-force balancing may be used at a single point, preferably above the center of mass of the model 10.

Internal Rotation Balancing

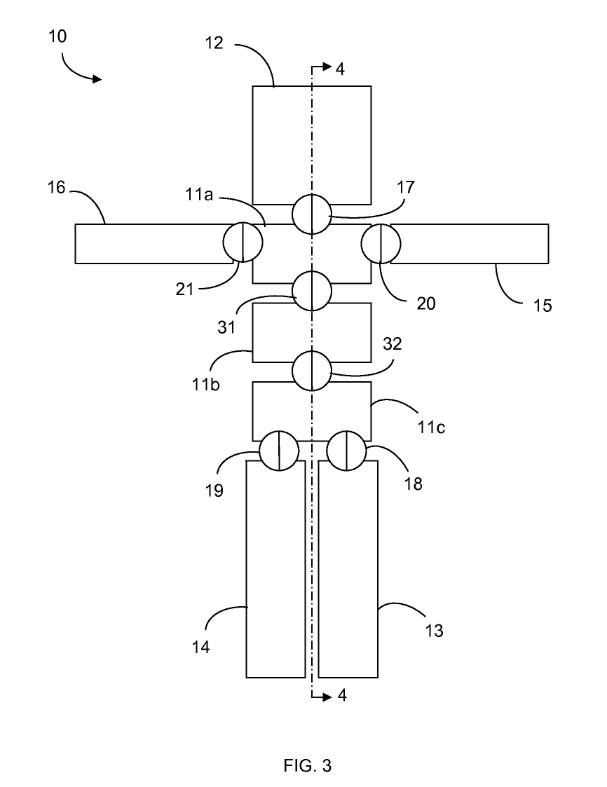

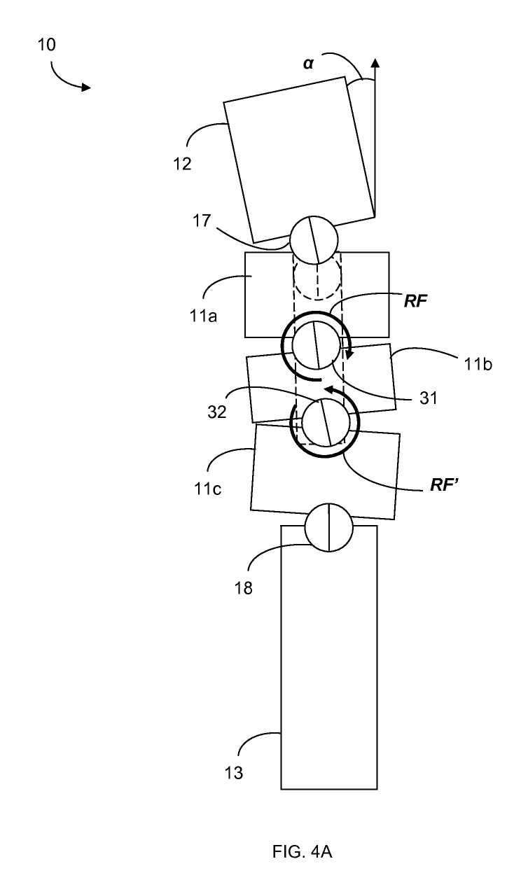

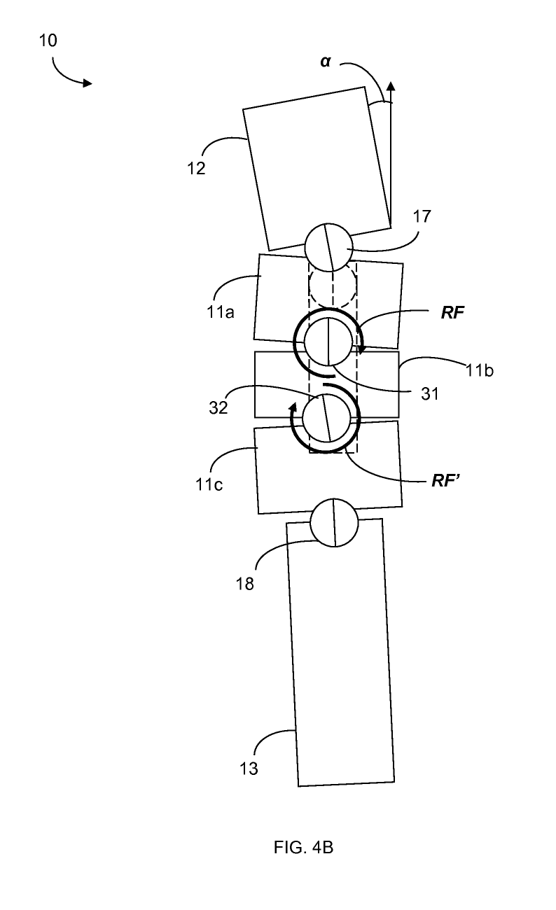

Referring to FIGS. 3 and 4A-B, the control system may balance the model 10 in an upright position by substantially continuously detecting the orientation of either or both of the torso 11 and head 12 and applying one or more rotational forces RF, RF′ to one or more torso joints 31, 32 when the model 10 begins to lean. As shown in the example of FIG. 3, the torso 11 may be segmented into an upper torso 11a, middle torso 11b, and lower torso 11c. The upper torso 11a is attached to the head 12 via the neck joint 17 and to the arms 15, 16 via the shoulder joints 20, 21. The middle torso 11b is attached to the upper torso 11a via the upper torso joint 31. The lower torso 11c is attached to the middle torso 11b via the lower torso joint 32, and is attached to the legs 13, 14 via the hip joints 18, 19.

The rotational forces RF, RF′ counterbalance the model 10 against the direction of the lean by rotating one or more of the torso segments to change the model's 10 center of gravity. Preferably, the control system first obtains the angle α of the head 12 with respect to vertical, but alternatively the control system may use the angle of the torso 11. The control system uses the angle to compute at least the force RF to be imparted on one of the torso joints 31, 32. Preferably, the force RF is applied to the upper torso joint 31 to rotate the upper torso 11a in the opposite direction of the lean, shifting the center of gravity of the model 10 to return the model 10 to the upright position under the influence of the simulation's gravity. The control system may compute a second rotational force RF′ which may be applied to the lower torso joint 32. Further rotational forces may be computed for models 10 having more torso joints, with additional torso joints improving the balance of the model 10. In one embodiment, shown in FIG. 4A, the second rotational force RF′ may be in the opposite direction of the first rotational force RF to counterbalance the movement of the upper torso 11a, similarly to the function of a human spine with the torso joints 31, 32 acting as vertebrae. In another embodiment, shown in FIG. 4B, the rotational forces RF and RF′ are in the same direction, allowing a greater degree of movement in the center of gravity of the model 10 than if a single torso joint were rotated. The process of determining the lean and rebalancing the torso joints 31, 32 is repeated substantially continuously, preferably with a frequency equal or approximately equal to the frame rate of the simulation.

External Force Movement

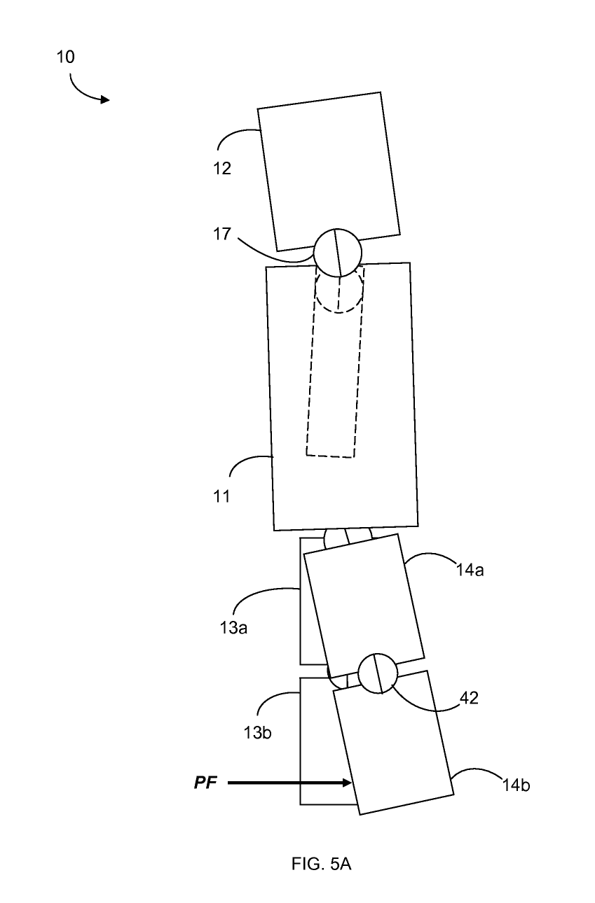

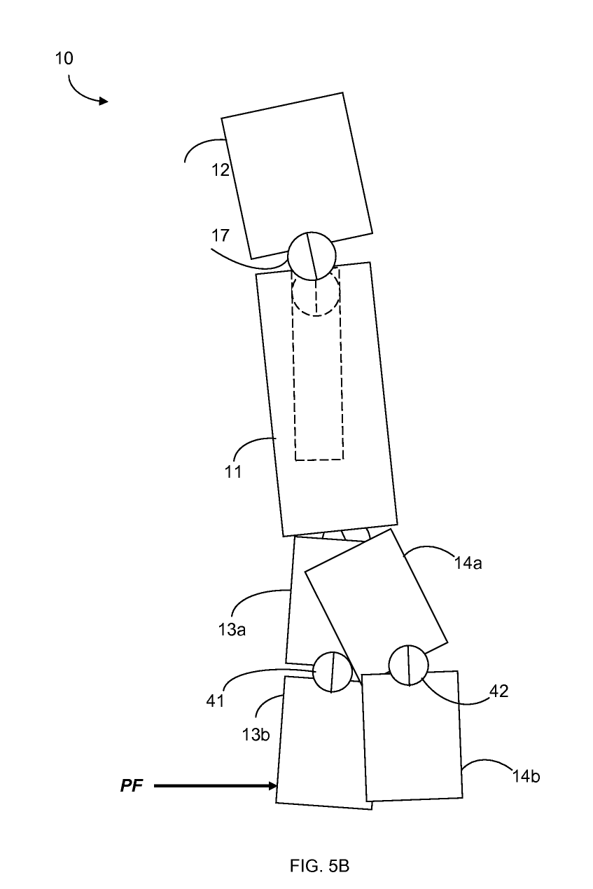

The entity may be caused to move through and interact with the simulated environment by applying external forces to the model's 10 bones. Being recognized as collision bodies within the physics engine, the bones essentially stack upon the surface and upon each other, and are balanced substantially vertically by one or both of the above balancing methods. Referring to FIGS. 5A-B, in conjunction with this balancing, the application of a pushing force PF at or near the bottom of each leg 13, 14 in alternating succession will cause the legs 13, 14 to rotate around their respective hip joints 18, 19 in the direction of the pushing force PF. The pushing force PF is also applied so that it imparts momentum to the model 10 in the direction of the pushing force PF. When the force PF is removed from the leg, it falls back to the surface due to gravity. This combination of pushing, rotation, and falling simulates walking. As shown in FIGS. 5A-B, the model 10 may have a left knee joint 41 and right knee joint 42, separating each leg 13, 14 into a thigh 13a, 14a and shin 13b, 14b. This improves the model's 10 balance while walking because the shin 13b, 14b rotates back toward vertical faster than the thigh 13a, 14a while the leg 13, 14 is falling back toward the surface, allowing the model 10 to keep its “feet” substantially below its center of gravity.

Movement of the entity in the direction of the pushing force PF may be aided by applying one or more additional forces to components of the model 10, such as a pushing force upon the back of the torso 11 or a pulling force upon the front of the torso 11. External forces may be used to cause the entity to perform other particular actions, such as jumping, kicking, and punching or otherwise raising the entity's arms or hands. The components of the applied forces will depend on the properties of the model 10 and the desired action. The use of external forces to animate the entity in real time provides a higher degree of accuracy in the entity's interaction with the environment than if the movements were pre-animated. For example, since the model's 10 legs 13, 14 are moving under the influence of the environment's physics, properties of the entity's stride will vary with the surface terrain. The model 10 may trip on a rock or log instead of unrealistically walking right over it. In another example, an entity having a pre-animated “punch” can either execute the movement or be prevented from executing it, depending on the conditions set at the time the “punch” input is received. In contrast, using the presently described control system the movement will be attempted regardless of the conditions, but the result will be determined by conditions including the position of the punching arm, the distance to other objects in the simulation, and whether other forces are being applied to the arm or model 10.

It will be understood that in an interactive environment, the external forces that cause entity locomotion may be applied in response to a user's input, such as a key press or mouse click. Application of the forces may vary, including without limitation: application of a predetermined force and duration upon receiving the input; repeated application of the force with constant or varying magnitude and duration as long as the input is received, such as when a key is held down; application of the force for as long as the input is received, such as when a key is held down to cause the entity to walk; or application of the force with increasing magnitude as long as the input is received. Other pushing or pulling forces may be applied without user input. For example, an entity may be made to “fly” within the simulation by substantially continuously toggling the application of a pushing or pulling force in a substantially vertical direction, the force being greater than the simulation's gravity.

Internal Rotation Movement

Entity locomotion may be powered by rotating the joints in the model 10 in the same way that muscles rotate the joints of real-life animals. The joint rotations may be performed using known principles of kinematics, with force calculations being influenced by the physics engine. In one embodiment, the control system uses a combination of forward and inverse kinematics equations to animate entity movement in real time. Specifically, forward kinematic equations are applied to rotate particular joints in response to user input, while inverse kinematic equations are applied to position the bones within the environment after the forward kinematics have finished operating. For example, as the user holds down the “walk forward” key, the control system performs the following actions:
1. apply rotation to the left hip joint;
2. compute the left leg position at the left hip joint's rotation (forward kinematics);
3. complete rotation of the left hip joint and switch to rotating the right hip joint;
4. compute rotation of left hip joint as the left leg falls back to the surface (inverse kinematics);
5. compute the right leg position at the right hip joint's rotation (forward kinematics);
6. complete rotation of the right hip joint and switch to rotating the left hip joint;
7. compute rotation of right hip joint as the right leg falls back to the surface (inverse kinematics);
8. repeat steps 1-7.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

I claim:

1. A method for simulating an entity within a computer simulation created by a processing engine, the method comprising:
a) providing a ragdoll model to the processing engine, the ragdoll model representing the entity within the simulation and comprising a plurality of bones each bone connected to at least one other bone by a joint; and
b) effecting locomotion of the ragdoll model in real time according to predetermined physical rules of the computer simulation.

2. The method of claim 1 wherein effecting locomotion of the ragdoll model comprises balancing the ragdoll model in a substantially upright position.

3. The method of claim 2 wherein balancing the ragdoll model comprises substantially continuously:
a) determining a direction and an amount that the ragdoll model is leaning; and
b) applying a corrective force to the ragdoll model to return the model to the substantially upright position.

4. The method of claim 3 wherein determining the direction and the amount that the ragdoll model is leaning comprises measuring at least one angle that one of the bones is tilted with respect to a reference line.

5. The method of claim 4 wherein measuring at least one angle comprises measuring the angle of the bone with respect to vertical along each non-vertical axis of the simulation.

6. The method of claim 3 wherein the corrective force comprises a direction and a magnitude, the method further comprising using the determined direction and amount to determine the corrective force.

7. The method of claim 6 wherein the computer simulation uses a vertical axis and at least one non-vertical axis perpendicular to the vertical axis, and wherein:
a) determining the direction and amount that the ragdoll model is leaning comprises measuring the angle with respect to vertical along each non-vertical axis at which one of the bones is tilted; and
b) using the determined direction and amount to determine the corrective force comprises obtaining the direction of the corrective force from the one or more measured angles.

8. The method of claim 7 wherein obtaining the direction of the corrective force from the one or more measured angles comprises:
a) converting the measured angles into a Euclidean vector having components along each axis, each component indicating the amount that the bone is tilted along the respective axis; and
b) choosing the direction of the corrective force to be substantially opposite at least one of the components of the Euclidean vector.

9. The method of claim 7 wherein the magnitude of the corrective force is predetermined.

10. The method of claim 7 wherein the magnitude of the corrective force increases as the measured angles increase.

11. The method of claim 3 wherein the ragdoll model comprises a torso and one or more legs attached to the torso, and wherein effecting locomotion of the ragdoll model comprises applying an external force to one or more of the legs to simulate walking.

12. The method of claim 3 wherein the ragdoll model comprises a torso and one or more legs each attached to the torso by a hip joint, and wherein effecting locomotion of the ragdoll model comprises:
a) applying a rotational force to each hip joint; and
b) applying forward kinematics equations to determine the position of each leg after the rotational force is applied in order to simulate walking.

13. The method of claim 2 wherein balancing the ragdoll model comprises substantially continuously:
a) determining a direction and an amount that the ragdoll model is leaning; and
b) applying one or more rotational forces to one or more joints within the ragdoll model to counterbalance the ragdoll model against the direction.

14. The method of claim 13 wherein one rotational force is applied equally to each joint.

15. The method of claim 14 wherein the rotational force is opposite the direction that the ragdoll model is leaning.

16. The method of claim 13 comprising a plurality of rotational forces, the rotational forces comprising:
a) a first rotational force that is opposite the direction that the ragdoll model is leaning, the first rotational force being applied to a first joint; and
b) a second rotational force that is in substantially the same direction as the direction that the ragdoll model is leaning, the second rotational force being applied to a second joint.

17. The method of claim 13 wherein the ragdoll model comprises a torso having a plurality of torso joints, the rotational forces being applied to the torso joints to counterbalance the ragdoll model.

18. The method of claim 13 wherein balancing the ragdoll model further comprises substantially continuously:
a) determining a direction and an amount that the ragdoll model is leaning; and
b) applying a corrective force to the ragdoll model to aid in returning the ragdoll model to the substantially upright position.

19. The method of claim 13 wherein the ragdoll model comprises a torso and one or more legs attached to the torso, and wherein effecting locomotion of the ragdoll model comprises applying an external force to one or more of the legs to simulate walking.

20. The method of claim 13 wherein the ragdoll model comprises a torso and one or more legs each attached to the torso by a hip joint, and wherein effecting locomotion of the ragdoll model comprises:
a) applying a rotational force to each hip joint; and
b) applying forward kinematics equations to determine the position of each leg after the rotational force is applied in order to simulate walking.
